(19) United States
(12) Patent Application Publication
(10) Pub. No.: US 2009/0319723 A1
(43) Pub. Date: Dec. 24, 2009

(54) METHOD AND DEVICE FOR BINDING A NON-VOLATILE STORAGE DEVICE WITH A CONSUMER PRODUCT

(75) Inventors: Rajesh Grover, Singapore (SG); Jeroen Steenblik, Singapore (SG); Jeroen Koster, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/438,556

(22) PCT Filed: Aug. 23, 2007
(86) PCT No.: PCT/IB2007/053366

§ 371 Date: Feb. 24, 2009

(30) Foreign Application Priority Data
Aug. 29, 2006 (EP) 06119683.8

(51) Int. Cl. G06F 12/00

(52) U.S. Cl. 711/103; 711/115; 711/156; 711/111; 711/E12.001

(57) ABSTRACT

A method is disclosed for binding a non-volatile storage device (110) with a consumer product (100) suitable for a mass production environment. The non-volatile storage device is provided with a predetermined identifier (105). The predetermined identifier indicates that the non-volatile storage device is to be bound to the consumer product. The consumer product detects insertion of the non-volatile storage device and reads the predetermined identifier. The consumer product then writes predetermined information regarding the consumer product (125) on the storage device, such that the non-volatile storage device and the consumer product are bound. The predetermined identifier may be a file with a predetermined name, or a file comprising a predetermined data sequence. The predetermined information may be detailed information about the consumer product, such as consumer product type or model number or installed software version.

### FIELD OF THE INVENTION

The invention relates to a method for binding a non-volatile storage device with a consumer product.

The invention further relates to a consumer product for binding with a non-volatile storage device.

The invention further relates to a non-volatile storage device for binding with a consumer product.

The invention further relates to a method for operating a consumer product for binding a non-volatile storage device with the consumer product.

The invention further relates to a program element.

The invention further relates to a computer-readable medium.

### BACKGROUND OF THE INVENTION

Consumer products such as a Set-Top-Boxes, digital video recording devices, mobile phones, DVD players/recorders, televisions and MP3 players are generally controlled by embedded software or firmware. Such consumer products are quite complex and it can occur that untested portions of the software may comprise errors, such errors are often termed bugs. Such software bugs should ideally be corrected by upgrading the software. Therefore it is beneficial to provide end user support for consumer products. Such support may be provided using a non-volatile storage medium.

However, to identify the non-volatile storage medium as suitable for the special purpose of supporting the end user a unique binding process between a consumer electronics device and the non-volatile storage medium is required. European patent application EP 1 100 018 A2 discloses a USB interface equipped device wherein a method for communication control of a USB equipped device is disclosed. The method discloses a USB equipped device that has a vendor identification (VID), a product identification (PID) and a device identification number (DID) that is different from the VID and PID. The DID may be set by a rotary switch, dip switch, a non-volatile ROM and the like to give a given DID to a USB equipped device. The method comprises transmitting the DID, together with the VID and the PID to a host computer when the USB equipped device is plugged in; identifying in the host computer the model of the USB quipped device based upon the transmitted VID and PID and identifying a USB equipped device as a target of communication among a plurality of USB equipped devices using the DID transmitted, thereby to establish communication with said USB equipped device.

Binding the devices in the factory costs machinery and time and therefore money so any steps taken should be simple. It is also important that any handling of the non-volatile storage medium does not require a unique device or a unique communication protocol, such as one according to EP 1 100 018 A2. Specifically creating the non-volatile storage medium for the consumer electronics device complicates the management of the supply chain and can render unused stock as worthless when demand for the consumer electronics devices fluctuates. A further boundary condition is that generic non-volatile storage devices may be used with the consumer electronics device without being bound to the consumer electronics device.

Accordingly the inventors devised the present invention.

### BRIEF SUMMARY OF THE INVENTION

It would be advantageous to achieve a binding of a non-volatile storage device with a consumer product in a manner suitable for mass production.

Accordingly, there is provided, in a first aspect of the present invention, a method for binding a non-volatile storage device with a consumer product, the method comprising storing a predetermined identifier on the non-volatile storage device, the predetermined identifier indicating that the non-volatile storage device is to be bound to the consumer product, detecting insertion of the non-volatile storage device into the consumer product, detecting the predetermined identifier on the non-volatile storage device inserted into the consumer product and storing predetermined information regarding the consumer product on the non-volatile storage device inserted into the consumer product to bind the non-volatile storage device to the consumer product.

According to a second aspect of the invention, there is provided, a consumer product for binding with a non-volatile storage device, the consumer product comprising a means for reading from the non-volatile storage device a predetermined identifier, the predetermined identifier indicating that the non-volatile storage device is to be bound to the consumer product and a means for writing predetermined information regarding the consumer product on the non-volatile storage device to bind the non-volatile storage device to the consumer product.

According to a third aspect of the invention, there is provided, a non-volatile storage device for binding with a consumer product, the device comprising a first non-volatile storage area for storing predetermined information regarding the consumer product, a second non-volatile storage area for storing a predetermined identifier, the predetermined identifier indicating that the non-volatile storage device is to be bound to the consumer product and a third non-volatile storage area for storing at least one file system for providing access to the first non-volatile storage area and the second non-volatile storage area.

According to a fourth aspect of the invention, there is provided, a method for operating a consumer product for binding a non-volatile storage device with the consumer product, the method comprising detecting insertion of the non-volatile storage device into the consumer product, detecting a predetermined identifier on the non-volatile storage device inserted into the consumer product, the predetermined identifier indicating that the non-volatile storage device is to be bound to the consumer product and storing predetermined information regarding the consumer product on the non-volatile storage device inserted into the consumer product to bind the non-volatile storage device to the consumer product.

According to a fifth aspect of the invention, there is provided, a program element directly loadable into the memory of a programmable device, comprising software code portions for performing, when said program element is run on the device, a method of binding a non-volatile storage device with a consumer product, the method comprising detecting insertion of the non-volatile storage device into the consumer product, detecting a predetermined identifier on the non-volatile storage device inserted into the consumer product, the predetermined identifier indicating that the non-volatile storage device is to be bound to the consumer product and storing predetermined information regarding the consumer product on the non-volatile storage device inserted into the consumer product to bind the non-volatile storage device to the consumer product.

According to a sixth aspect of the invention, there is provided, a computer-readable medium directly loadable into the memory of a programmable device, comprising software code portions for performing, when said code portions are run on the device, a method of binding a non-volatile storage device with a consumer product, the method comprising detecting insertion of the non-volatile storage device into the consumer product, detecting a predetermined identifier on the non-volatile storage device inserted into the consumer product, the predetermined identifier indicating that the non-volatile storage device is to be bound to the consumer product and storing predetermined information regarding the consumer product on the non-volatile storage device inserted into the consumer product to bind the non-volatile storage device to the consumer product.

It has been recognized that one consumer product from a set of identical consumer products may be bound to one non-volatile storage device from a set of identical non-volatile storage devices by providing a non volatile storage medium that can be read from and written to using the consumer product. Both the set of identical consumer products and the set of identical non-volatile storage devices may then be mass-produced and a one time binding process can differentiate between unbound but bind-able devices, bound devices and unbind-able devices. A co-operation by using the provision of a predetermined identifier allows the binding process to proceed in a factory during production or upon first use after factory shipment in an automatic manner without any intervention from factory workers or end users. Therefore this provides a simple and effective way to bind the non-volatile storage device and the consumer device. The predetermined identifier stored on the non-volatile storage device may indicate that the predetermined information regarding the consumer product should be written to the non-volatile storage device to complete this binding process. The predetermined identifier therefore allows the consumer product to quickly differentiate between an arbitrary non-volatile storage device, such as a generic USB flash disk, and a non-volatile storage device to be used to provide end user support for the consumer product.

In one embodiment the predetermined information may comprise an identifier of a product type of the consumer product. The consumer product may use the product type of the consumer product to indicate that the non-volatile storage device is already bound to a consumer product.

In another embodiment the predetermined information may comprise a unique identifier of the consumer product for differentiating amongst consumer products of the same product type. The consumer product may use the unique identifier to indicate that the non-volatile storage device is already bound to a consumer product and then differentiate between consumer products of the same product type.

In yet another embodiment the predetermined information may further comprise a version number of software currently installed on the consumer product. The consumer product may use the version number as an indication that the non-volatile storage device is already bound to a consumer product.

In another embodiment the predetermined identifier may be a file with a predetermined name or a file comprising a predetermined data sequence. The use of a file with a predetermined name or a file comprising a predetermined data sequence allows standard read/write commands available for all non-volatile storage devices to be used to indicate that the non-volatile storage device is a device suitable for providing end user support. No special communication is required beyond those found in the operation of generic non-volatile storage devices.

In another embodiment the non-volatile storage device may be a universal serial bus non-volatile storage device and the means for writing and the means for reading may be a universal serial bus interface. Universal serial bus non-volatile storage devices are cost effective non-volatile storage devices and are simple to interface to consumer products.

In another embodiment the non-volatile storage device may be a flash storage device or a hard disk drive device and the means for writing and the means for reading may be an interface compatible with the flash storage device or the hard disk drive device. Flash storage devices and hard disk drive devices are cost effective non-volatile storage devices and are simple to interface to consumer products with interfaces commonly applied in consumer products.

In a further embodiment the non-volatile storage device may be an optical disc and the means for writing and the means for reading may be an optical drive. In consumer products already employing optical storage such an optical disc may be used to upgrade the software on the consumer products with zero added cost to the consumer.

In a further embodiment the at least one file system may be a Compact Disc File System and/or a Hierarchical File System. These are common file systems readable upon consumer and computer products.

In another embodiment the non-volatile storage device may be an SD device, a memory stick device, a MMC device or a Compact Flash device. These are widely available flash based non-volatile storage devices.

In a further embodiment a fourth non-volatile storage area may be provided in the non-volatile storage device for storing user data. This allows a user to also store data of interest to the user in any remaining storage space not required for upgrading the software.

In another embodiment the second non-volatile storage area may comprise the first non-volatile storage area. Such an embodiment allows the predetermined information regarding a consumer product and the predetermined identifier to be stored together and simplifies accessibility.

In an embodiment the second non-volatile storage area may be a hidden non-volatile storage area hidden from a user during normal operation. This allows upgrade software top be protected from accidental erasure by the user during normal usage. For example, when the non-volatile storage device is also used in a computer product.

In a further embodiment a consumer product according to the invention may be realized as at least one of the group consisting of a Set-Top-Box device, a digital video recording device, a network-enabled device, a conditional access system, a portable audio player, a portable video player, a mobile phone, a DVD player, a CD player, a hard disk based media player, an Internet radio device, a computer, a television, a public entertainment device and an MP3 player. However, these applications are only exemplary.

The data processing required according to the invention can be realized by a computer program, that is to say by software, or by using one or more special electronic optimization circuits, that is to say in hardware, or in hybrid form, that is to say by means of software components and hardware components.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates a consumer product interfacing with a non-volatile storage device.

FIG. 2 illustrates a flowchart for binding a non-volatile storage device with a consumer product.

FIG. 3 illustrates the internal layout of a non-volatile storage device suitable for use in binding a non-volatile storage device with a consumer product.

FIG. 4 illustrates a computer product interfacing with a non-volatile storage device to acquire upgrade software from a remote server after binding the non-volatile storage device with a consumer product.

FIG. 5 illustrates a consumer product reading upgrade software from a non-volatile storage device.

FIG. 6 illustrates the internal construction of a consumer product and a selection of embodiments of a non-volatile storage device for use in binding a non-volatile storage device with the consumer product.

FIG. 7 illustrates the internal construction of a consumer product comprising an optical disc drive unit and an optical disc embodiment of a non-volatile storage device for use in binding a non-volatile storage device with the consumer product.

The Figures are schematically drawn and not true to scale, and the identical reference numerals in different Figures refer to corresponding elements. It will be clear for those skilled in the art, that alternative but equivalent embodiments of the invention are possible without deviating from the true inventive concept, and that the scope of the invention will be limited by the claims only.

### DETAILED DESCRIPTION OF THE INVENTION

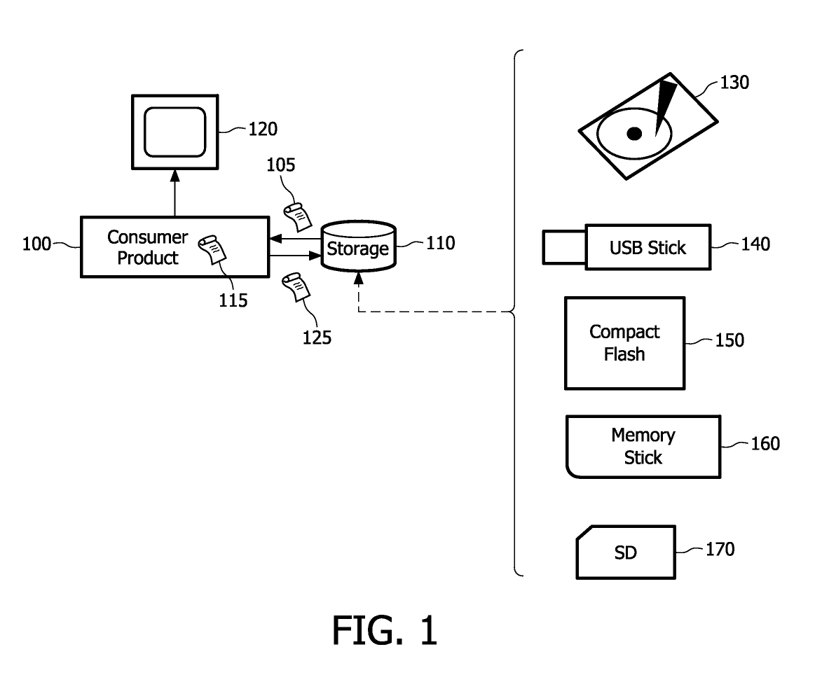

FIG. 1 illustrates a consumer product 100. The consumer product 100 may be embodied as a DVD recorder, a Set-Top-Box device, a digital video recording device, a network-enabled device, a conditional access system, a portable audio player, a portable video player, a mobile phone, a DVD player, a CD player, a hard disk based media player, an Internet radio device, a computer, a television, a public entertainment device or an MP3 player. However, these applications are only exemplary. When the consumer product 100 does not in itself provide a screen then a display 120 may be provided for rendering audio-video content. The display 120 may also incorporate speakers (not shown) to assist in the rendering of audio. Speakers may also be provided separately. It is common for software contained within the consumer product 100 to be upgraded. Such software is often termed embedded software 115 or firmware and allows the consumer product 100 to perform the normal operation expected by a user. The embedded software 115 may need to be upgraded to provide extra functionality to the user or to correct software bugs found in the embedded software 115 during testing in the field.

Since consumer products in general do not possess a direct connection to the Internet upgrading the embedded software 115 is an awkward task for the user. This normally involves the user having to identify the exact type or model number of the consumer product 100 and to identify the current version of the embedded software 115 installed on the consumer product 100. Then using a personal computer the user can acquire the latest software using a Web browser interface, before storing the latest software on a storage device to transfer it to the consumer product 100.

Therefore whilst it is beneficial to provide end user support for consumer products, such support is not always possible online and may be provided using a non-volatile storage device 110. However, to identify the non-volatile storage device 110 as suitable for the special purpose of supporting the end user then a unique binding process between the consumer product 100 and the non-volatile storage device 110 is required.

Binding the devices in the factory costs machinery and time and therefore money so any steps taken should be simple. It is also important that any handling of the non-volatile storage medium does not require a unique device or a unique communication protocol specifically created for the consumer electronics device. This is because this complicates the management of the supply chain and can render unused stock as worthless when demand for the consumer electronics devices fluctuates. A further boundary condition is that generic non-volatile storage devices may be used with the consumer product 100 without being bound to the consumer product 100.

In FIG. 1 it is illustrated that the non-volatile storage device 110 may be bound to the consumer product 100. The non-volatile storage device 110 is preferably a removable storage device. The non-volatile storage device 110 may be associated with the consumer product 100 by reading a predetermined identifier 105 from the non-volatile storage device 110. The predetermined identifier 105 may be a special file. The predetermined identifier 105 may be indicated merely by a unique name of the special file or by unique data contained within the special file, i.e. a predetermined data sequence. Of course, many other implementations are possible. The function of the predetermined identifier 105 is to merely indicate to the consumer product 100 that the non-volatile storage device 110 should be used in relation to the support of the consumer product 100. Using the predetermined identifier 105 the consumer product 100 may then identify the non-volatile storage device 110 as a support non-volatile storage device. Such a support non-volatile storage device may be specifically associated with the consumer product 100 to provide support functionality to ensure that the consumer product 100 is kept up to date with the latest software release or for other support purposes. The non-volatile storage device 110 may be sold together with the consumer product 100 or separately.

As illustrated in FIG. 1 the non-volatile storage device 110 may be embodied as a hard disk drive 130, a Universal Serial Bus (USB) stick 140, a Compact Flash device 150, a Memory Stick device 160 or a SD device 170. Other equivalent devices may also be used that provide non-volatile read/write storage functionality.

In FIG. 1 the consumer product 100 is also shown storing predetermined information regarding the consumer product 125 on the non-volatile storage device 110. This may occur after the non-volatile storage device 110 has been associated with the consumer product 100 by reading the predetermined identifier 105. The predetermined information regarding the consumer product 125 may be a type or model number of the consumer product 100 or the version number of the embedded software 115 currently installed on the consumer product 100. The predetermined information regarding the consumer product 125 is useful to allow new software to be identified automatically for the consumer product 100. The user therefore no longer has to identify the product type of the consumer product 100 from the label or product manual. The predetermined information regarding the consumer product 125 may also comprise a unique identifier of the consumer product 100 for differentiating amongst consumer products of the same product type. A consumer possessing a plurality of consumer products of the same product type therefore no longer has to differentiate between each of the consumer products of the same product type.

The process of reading the predetermined identifier 105 from the non-volatile storage device 110 and writing the predetermined information regarding the consumer product 125 on the non-volatile storage device 110 effectively binds the non-volatile storage device 110 to the consumer product 100 for support purposes.

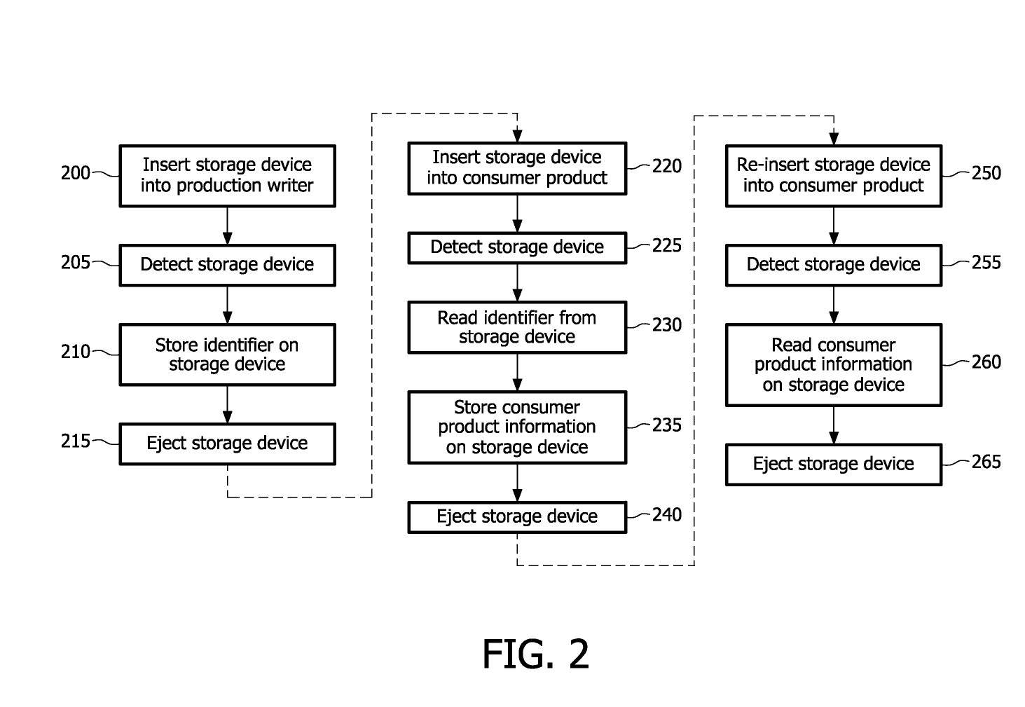

In FIG. 2 a flowchart is illustrated indicating numerous phases of a method in accordance with an embodiment of the invention. In the first phase, namely steps 200 though 215, the non-volatile storage device 110 co-operates with a recording device, preferably in a factory environment. At step 200 the non-volatile storage device 110 is inserted into the recording device. At step 205 the recording device detects the non-volatile storage device 110. At step 210 the recording device stores the predetermined identifier 105 on the non-volatile storage device 110. The first phase ends at step 215 where the non-volatile storage device 110 is ejected from the recording device. Again, it is preferable if the first phase occurs in a factory environment. The recording device may be any suitable device capable of storing a file or data on the non-volatile storage device 110. The recording device may use standard read/write commands to store the predetermined identifier 105 on the non-volatile storage device 110.

In the second phase, namely steps 220 though 240, the non-volatile storage device 110 co-operates with the consumer product 100. At step 220 the non-volatile storage device 110 is inserted into the consumer product 100. The consumer product 100 detects the non-volatile storage device 110 at step 225 and may read the predetermined identifier 105 from the non-volatile storage device 110 at step 230. The consumer product 100 may use standard read commands to read the predetermined identifier 105 from the non-volatile storage device 110. At step 235 the consumer product 100 may use standard write commands to write the predetermined information regarding the consumer product 125 on the non-volatile storage device 110. At step 240 the second phase ends where the non-volatile storage device 110 is ejected from the consumer product 100. The process of reading the predetermined identifier 105 from the non-volatile storage device 110 and writing the predetermined information regarding the consumer product 125 on the non-volatile storage device 110 effectively binds the non-volatile storage device 110 to the consumer product 100 for support purposes. Such co-operation by using the provision of the predetermined identifier 105 allows the second phase of the binding process to proceed in a factory during production or upon first use after factory shipment in an automatic manner without any intervention from factory workers or end users. The second phase may, therefore, occur in a factory environment or after leaving the factory environment.

In an optional third phase, namely steps 250 though 265, the non-volatile storage device 110 may again co-operate with the consumer product 100. At step 250 the non-volatile storage device 110 is re-inserted into the consumer product 100. At step 255 the consumer product 100 detects the non-volatile storage device 110 and may, at step 260, further detect the predetermined information regarding the consumer product 125 stored on the non-volatile storage device 110 during the second phase. This may be achieved by reading from the non-volatile storage device 110 using standard read commands. The consumer product 100, by reading the predetermined information regarding the consumer product 125 stored on the non-volatile storage device 110, is now aware that the non-volatile storage device 110 has already been bound to the consumer product 100 and no further binding action is necessary. Of course, normal support actions may now be performed. Such support actions may, for example, be the upgrading of the embedded software 115. The third, and final, phase ends at step 265 where the non-volatile storage device 110 is ejected from the consumer product 100. The third phase will most likely occur in a home environment during user by the end user.

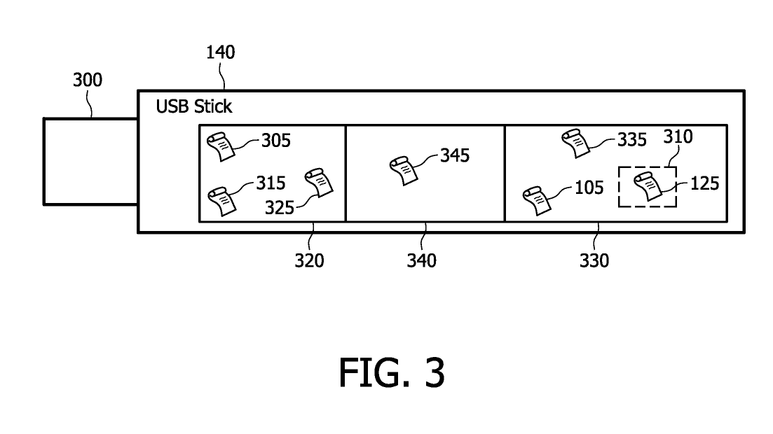

In FIG. 3 the internal layout is shown of the non-volatile storage device 110, embodied as a USB stick 140. The USB stick 140 may be suitable for use in upgrading software on the consumer product or for other support actions. In FIG. 3 the USB stick 140 has a USB interface connector 300 according to the USB standard. This allows the USB stick 140 to be used in any device operating according to the USB standard. The USB stick 140 of FIG. 3 is illustrated in a state after which the USB stick 140 has been assigned to co-operate with the consumer product 110, i.e. it is already bound to the consumer product 100. This may be indicated by the presence of the predetermined information regarding the consumer product 125, which may be stored in a first non-volatile storage area 310. The storage space of the USB stick 140 may be partitioned into multiple partitions. In FIG. 3 three partitions or areas are shown, namely a second non-volatile storage area 330, a third non-volatile storage area 320 and a fourth non-volatile storage area 340. It is not essential that three partitions be used. The first non-volatile storage area 310 may be stored within the second non-volatile storage area 330, or elsewhere. In an initial state (not shown), i.e. before being assigned to co-operate with the consumer product 100, the predetermined information regarding the consumer product 125 will not be present in the first non-volatile storage area 310, but the predetermined identifier 105 will be present. In this state the first non-volatile storage area 310 may not even have been created yet.

The third non-volatile storage area 320 may be a CDROM emulation zone and may be read only. It may be a separate partition, where here the term partition takes on the meaning as known in the technical area of personal computers. Another term for CDROM emulation is optical storage emulation. The objective of providing CDROM emulation is to allow a computer program 325 to run automatically when the USB stick 140 is inserted into a personal computer. This is useful to allow automatic upgrading of the embedded software 115. Some personal computer operating systems only allow optical storage devices to automatically run applications, therefore emulating a CDROM achieves the desired effect of automatically running the computer program 325. The computer program 325 may be an upgrade application that may read the predetermined information regarding the consumer product 125 from the USB stick 140. To ensure that the USB stick 140 may operate with multiple operating systems it is preferable to provide multiple file systems. For example, a Compact Disc File System (CDFS) 305 and a Hierarchical File System (HFS) 315 may both be provided. In the Compact Disc File System (CDFS) 305 a special system file named autorun.inf may be employed to allow the computer program 325 to run automatically. Access to the computer program 325 may also be provided in the Compact Disc File System (CDFS) 305. The Hierarchical File System (HFS) 315 may provide a Readme.txt file to instruct the user on how to run the computer program 325 and the Hierarchical File System (HFS) 315 may also provide access to the computer program 325. Preferably the size of the third non-volatile storage area 320 is large enough to provide for at least the Compact Disc File System (CDFS) 305 and the Hierarchical File System (HFS) 315 and the required data, such as the computer program 325.

The second non-volatile storage area 330 may be a hidden non-volatile storage area not normally accessible by the user. Providing a hidden non-volatile storage area ensures that the user does not accidentally erase files useful for upgrading the embedded software 115 of the consumer product 100. Preferably the second non-volatile storage area 330 would be hidden during normal use on a personal computer, but visible to the computer program 325 and on the consumer product 100. The second non-volatile storage area 330 may be accessible for reading and writing. Any file system may be used including proprietary file systems. The second non-volatile storage area 330 may be used to store the predetermined identifier 105, the first non-volatile storage area 310 and therein the predetermined information regarding the consumer product 125 and upgrade software 335. Preferably the size of the second non-volatile storage area 330 is large enough to provide for the required data items just described.

Optionally, a fourth non-volatile storage area 340 may be provided occupying all remaining storage space on the USB stick 140. The fourth non-volatile storage area 340 may be used by the user to store user data 345. The fourth non-volatile storage area 340 may therefore operate as a normal flash drive for the user. The fourth non-volatile storage area 340 may be accessible for reading and/or writing as desired by the user.

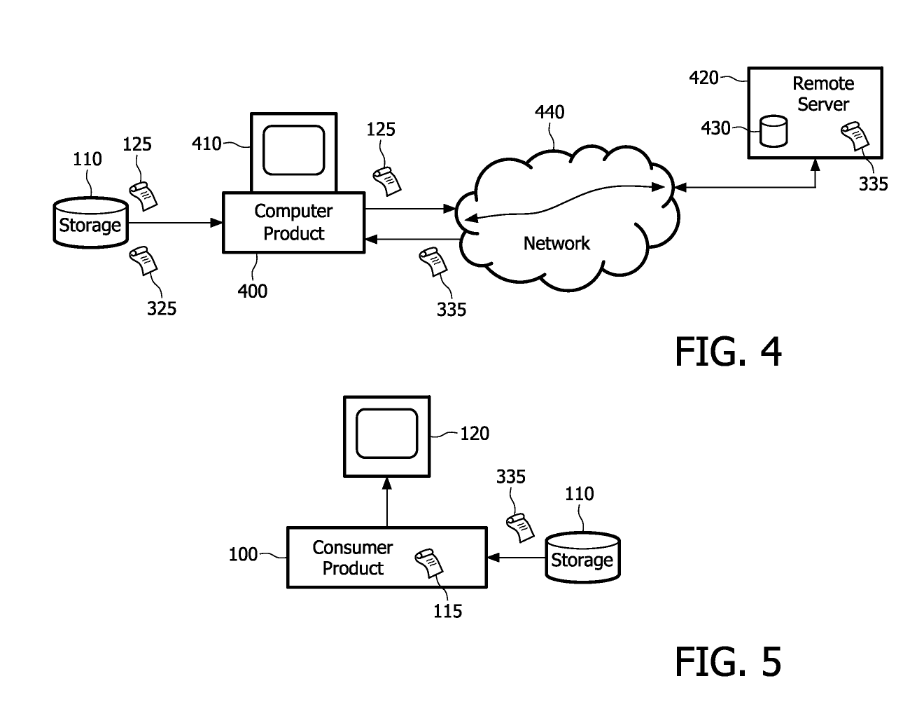

In FIG. 4 the non-volatile storage device 110, such as embodied by the USB stick 140, has been transferred by the user to a computer product 400. The computer product 400 may be a normal personal computer and operate in the known manner. The computer product 400 may have a monitor 410 for interacting with the user. Keyboards, mice and other user interface devices (all not shown) may also be used to allow effective user interaction. The computer product 400 may interface with the non-volatile storage device 110 in the known way and automatically detect and run computer program 325 from the non-volatile storage device 110. The computer program 325 allows further access to the predetermined information regarding the consumer product 125 on the non-volatile storage device 110. The computer program 325 may then access a remote server 420 via a network 440, such as the Internet. The computer program 325 may provide the predetermined information regarding the consumer product 125 to the remote server 420 and the remote server 420 may have a software database 430 from which the remote server 420 can identify the upgrade software 335 required to upgrade the consumer product 100 to the latest software version. The upgrade software 335 may be acquired by the computer program 325 and stored upon the non-volatile storage device 110 by the computer program 325. As noted in the text relating to FIG. 3 both the predetermined information regarding the consumer product 125 and the acquired upgrade software 335 may be stored in a hidden non-volatile storage area. In this case the computer program 325 should be able to access the hidden non-volatile storage area.

In FIG. 5 the non-volatile storage device 110 is illustrated after re-insertion into the consumer product 100. The upgrade software 335 may be retrieved from the non-volatile storage device 110 using the embedded software 115 already present on the consumer product 100. The consumer product 100 may then upgrade the embedded software 115 by replacing it with the upgrade software 335 either fully or partially. As far as the user is concerned the consumer product 100 has been upgraded with no more effort than inserting and removing the non-volatile storage device 110 a few times. The upgrading of the embedded software 115 was therefore achieved in a sensible and simple manner.

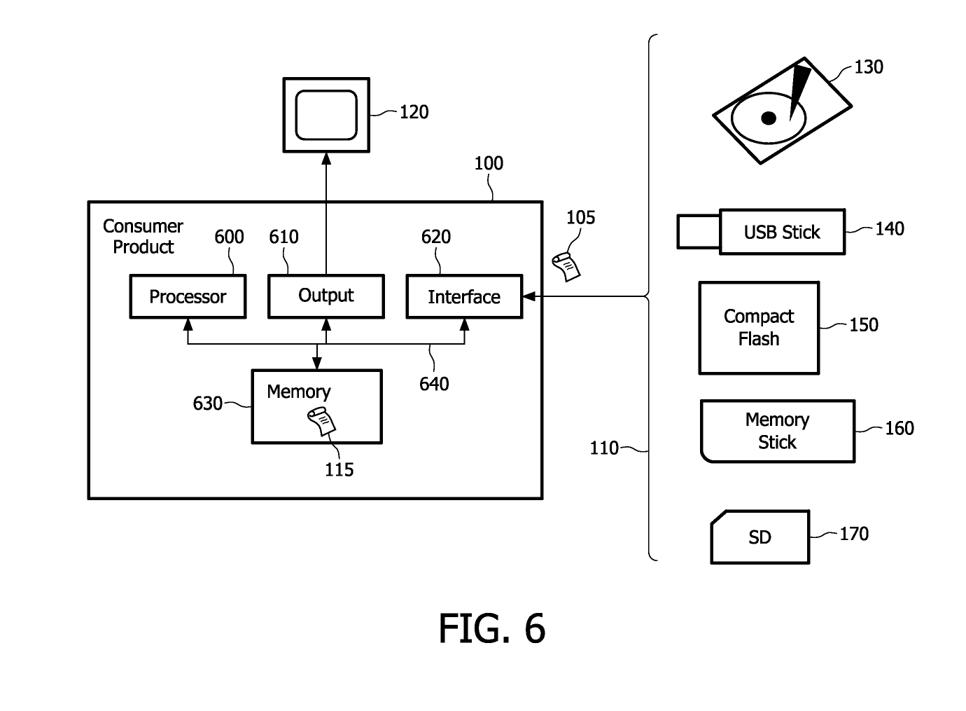

FIG. 6 shows in more detail an embodiment of the consumer product 100. The consumer product 100 may have a microcontroller or processor 600 for executing the embedded software 115 or after an upgrade the upgrade software 335. Memory 630 may be provided to assist the processor 600 in the execution of software code. The memory 630 may be non-volatile memory such a NOR or NAND flash, or it may be a hybrid memory comprising numerous memory partitions, such as read only memory (ROM), flash memory and randomly accessible volatile memory, i.e. RAM. Other possibilities are also foreseeable. The embodiment of FIG. 6 has an interface unit 620 suitable for interfacing with the non-volatile storage device 110. The exact form of interface unit 620 depends upon the embodiment of the non-volatile storage device 110. Numerous examples of the embodiment of the non-volatile storage device 110 are shown in FIG. 6. Each form of the interface unit 620 is well known to the skilled person. An output unit 610 may be provided to generate signals necessary for the display 120. The processor 600, the memory 630, the output unit 610 and the interface unit 620 may all communicate via a bus 640. Such a system bus is commonly applied and is well known to the skilled person. The non-volatile storage device 110 as shown in FIG. 6 only illustrates the second phase of the method according to the flowchart shown in FIG. 2. In reality the processor 600 of the consumer product 100 may execute numerous steps in the method according to the flowchart shown in FIG. 2. More specifically, the processor 600 may execute the second phase and the third phase of the method according to the flowchart shown in FIG. 2.

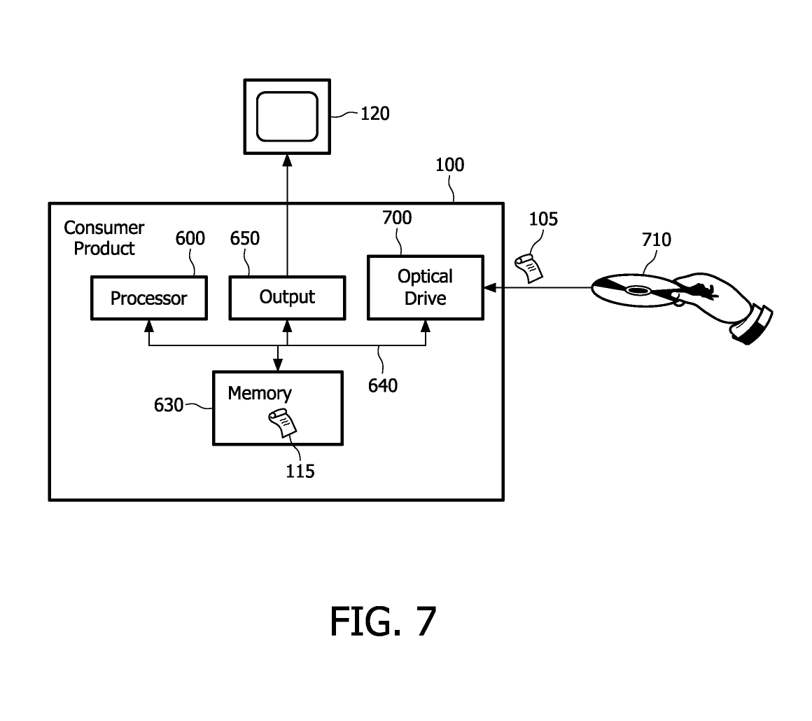

FIG. 7 shows in more detail a further embodiment of the consumer product 100. The consumer product 100 may comprise an optical drive 700 in place of the interface unit 620 of the embodiment of FIG. 6. Known optical drives may read and write Compact Discs, CDROM's, DVD's, DVD+/−RW, HD-DVD, Blu-Ray discs etc. In the embodiment of FIG. 7 the non-volatile storage device 110 is embodied as an optical disc 710. The non-volatile storage device 110 as shown in FIG. 7 again only illustrates the second phase of the method according to the flowchart shown in FIG. 2. The processor 600 may again execute the second phase and the third phase of the method according to the flowchart shown in FIG. 2.

In summary the invention discloses methods and devices for binding a non-volatile storage device with a consumer product suitable for a mass production environment. The non-volatile storage device is provided with a predetermined identifier. The predetermined identifier indicates that the non-volatile storage device is to be bound to the consumer product. The consumer product detects insertion of the non-volatile storage device and reads the predetermined identifier. The consumer product then writes predetermined information regarding the consumer product on the storage device, such that the non-volatile storage device and the consumer product are bound. The predetermined identifier may be a file with a predetermined name, or a file comprising a predetermined data sequence. The predetermined information may be detailed information about the consumer product, such as consumer product type or model number or installed software version.

It should be noted that the above-mentioned embodiments illustrate rather than limit the invention, and that those skilled in the art will be capable of designing many alternative embodiments without departing from the scope of the invention as defined by the appended claims. Furthermore, any of the embodiments described comprise implicit features, such as, an internal current supply, for example, a battery or an accumulator. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. A method for binding a non-volatile storage device (110) with a consumer product (100), the method comprising:
storing (210) a predetermined identifier (105) on the non-volatile storage device, the predetermined identifier (105) indicating that the non-volatile storage device is to be bound to the consumer product;
detecting (225) insertion of the non-volatile storage device into the consumer product;
detecting (230) the predetermined identifier (105) on the non-volatile storage device inserted into the consumer product; and
storing (235) predetermined information regarding the consumer product (125) on the non-volatile storage device inserted into the consumer product to bind the non-volatile storage device to the consumer product.

2. The method of claim 1 wherein the predetermined information comprises an identifier of a product type of the consumer product.

3. The method of claim 2 wherein the predetermined information further comprises a unique identifier of the consumer product for differentiating amongst consumer products of the same product type.

4. The method of claim 1, wherein the predetermined information further comprises a version number of software currently installed on the consumer product.

5. The method of claim 1 wherein the predetermined identifier is a file with a predetermined name or a file comprising a predetermined data sequence.

6. A consumer product (100) for binding with a non-volatile storage device (110), the consumer product comprising:
a means for reading (620, 700) from the non-volatile storage device a predetermined identifier (105), the predetermined identifier indicating that the non-volatile storage device is to be bound to the consumer product; and
a means for writing (620, 700) predetermined information regarding the consumer product (125) on the non-volatile storage device to bind the non-volatile storage device to the consumer product.

7. The consumer product of claim 6 wherein:
the non-volatile storage device is a universal serial bus non-volatile storage device (140); and
the means for writing and the means for reading is a universal serial bus interface (620).

8. The consumer product of claim 6 wherein:
the non-volatile storage device is a flash storage device (140, 150, 160, 170) or a hard disk drive device (130); and
the means for writing and the means for reading is an interface (620) compatible with the flash storage device or the hard disk drive device.

9. The consumer product of claim 6 wherein:
the non-volatile storage device is an optical disc (710); and
the means for writing and the means for reading is an optical drive (700).

10. The consumer product of claim 6 realized as at least one of the group consisting of:
a Set-Top-Box device;
a digital video recording device;
a network-enabled device;
a conditional access system;
a portable audio player;
a portable video player;
a mobile phone;
a DVD player;
a CD player;
a hard disk based media player;
an Internet radio device;
a television;
a public entertainment device; and
an MP3 player.

11. A non-volatile storage device (110) for binding with a consumer product (100), the device comprising:
a first non-volatile storage area (310) for storing predetermined information regarding the consumer product (125);
a second non-volatile storage area (330) for storing a predetermined identifier (105), the predetermined identifier indicating that the non-volatile storage device is to be bound to the consumer product; and
a third non-volatile storage area (320) for storing at least one file system for providing access to the first non-volatile storage area and the second non-volatile storage area.

12. The non-volatile storage device of claim 11 wherein the non-volatile storage device is a universal serial bus non-volatile storage device (140).

13. The non-volatile storage device of claim 11 wherein the non-volatile storage device is a flash storage device (140, 150, 160, 170) or a hard disk drive device (130).

14. The non-volatile storage device of claim 11 wherein the non-volatile storage device is an optical disc (710).

15. The non-volatile storage device of claim 11 wherein the at least one file system is a Compact Disc File System 305 and/or a Hierarchical File System 315.

16. The non-volatile storage device of claim 11 wherein the non-volatile storage device is an SD device (170), a memory stick device (160), a MMC device or a Compact Flash device (150).

17. The non-volatile storage device of claim 11 wherein the non-volatile storage device further comprises a fourth non-volatile storage area (340) for storing user data (345).

18. The non-volatile storage device of claim 11 wherein the second non-volatile storage area (330) comprises the first non-volatile storage area (310).

19. The non-volatile storage device of claim 11 wherein the second non-volatile storage area is a hidden non-volatile storage area hidden from a user during normal operation.

20. A method for operating a consumer product (100) for binding a non-volatile storage device (110) with the consumer product, the method comprising:
detecting (225) insertion of the non-volatile storage device into the consumer product;
detecting (230) a predetermined identifier (105) on the non-volatile storage device inserted into the consumer product, the predetermined identifier (105) indicating that the non-volatile storage device is to be bound to the consumer product; and
storing (235) predetermined information regarding the consumer product (125) on the non-volatile storage device inserted into the consumer product to bind the non-volatile storage device to the consumer product.

21. A program element directly loadable into the memory of a programmable device, comprising software code portions for performing, when said program element is run on the device, a method of binding a non-volatile storage device (110) with a consumer product (100), the method comprising:
detecting (225) insertion of the non-volatile storage device into the consumer product;
detecting (230) a predetermined identifier (105) on the non-volatile storage device inserted into the consumer product, the predetermined identifier (105) indicating that the non-volatile storage device is to be bound to the consumer product; and
storing (235) predetermined information regarding the consumer product (125) on the non-volatile storage device inserted into the consumer product to bind the non-volatile storage device to the consumer product.

22. A computer-readable medium directly loadable into the memory of a programmable device, comprising software code portions for performing, when said code portions are run on the device, a method of binding a non-volatile storage device (110) with a consumer product (100), the method comprising:
detecting (225) insertion of the non-volatile storage device into the consumer product;
detecting (230) a predetermined identifier (105) on the non-volatile storage device inserted into the consumer product, the predetermined identifier (105) indicating that the non-volatile storage device is to be bound to the consumer product; and
storing (235) predetermined information regarding the consumer product (125) on the non-volatile storage device inserted into the consumer product to bind the non-volatile storage device to the consumer product.
